(19) United States
(12) Patent Application Publication
(10) Pub. No.: US 2011/0219594 A1
(43) Pub. Date: Sep. 15, 2011

(54) TOOL DEVICE FOR CONNECTION OF A PLASTIC PIPE

(75) Inventor: Bernd Kaufmann, Hassfurt (DE)

(73) Assignee: Uponor Innovation Ab, Fristad (SE)

(21) Appl. No.: 13/121,837

(22) PCT Filed: Oct. 8, 2009
(86) PCT No.: PCT/EP2009/063112

§ 371 Date: May 31, 2011

(30) Foreign Application Priority Data
Oct. 10, 2008 (DE) 10 2008 051 284.2

(51) Int. Cl. B25B 27/02

(52) U.S. Cl. 29/237

(57) ABSTRACT

A tool device for the connection of a plastic pipe, particularly a plastic/metal composite pipe, to a fitting having a compression or sliding sleeve, has a housing (40), a drive element (20) that can be mechanically driven, which can be displaced selectively along a first movement direction or along a second movement direction, a pipe expanding tool (14) for expanding a pipe end (50) that can be slid onto a supporting sleeve (48) of a fitting (46), and a compression sleeve-pressing tool (16) or a sliding sleeve-sliding tool (16′) for pressing a compression sleeve (52) onto the expanded pipe end (50) having been slid onto the supporting sleeve (48) of the fitting (46′) or for sliding a sliding sleeve (52′) onto the expanded pipe end (50) having been slid onto the supporting sleeve (48). The drive element (20) actuates the pipe expanding tool (14) during movement along the first movement direction and actuates the compression sleeve-pressing tool (16) or the sliding sleeve-sliding tool (16′) during movement along the second movement direction.

The invention relates to a tool device for the connection of a plastic pipe, particularly a plastic/metal composite pipe to a fitting having a compression or sliding sleeve according to the preamble of the independent claims 1 and 2.

Such tool devices are known from the documents DE 42 38 700 C2 and DE 199 49 797 A1.

For the connection of plastic pipes, particularly plastic/metal composite pipes, it is known to use so-called inside sealing press fitting systems. With this, the pipe to be connected is slid onto a supporting sleeve of the fitting body, and using a compression sleeve surrounding one of the pipe ends, is pressed against the supporting sleeve. DE 101 37 078 C1 is one example of such a press fitting system.

Depending on the nominal widths of the pipes to be connected, an inside sealing press fitting system can be disadvantageous in that the supporting sleeve slid into the pipe leads to a cross sectional narrowing which is accompanied by an increase of the flow resistance. Therefore, fitting systems for the connection of plastic pipes are also known in which the pipe is expanded at its end to be connected, and the thusly expanded pipe end is slid onto the supporting sleeve of a fitting body. In this case, the inner diameter of the support sleeve is substantially the same as the inner diameter of the pipe to be connected. Next, a sliding sleeve is then pulled axially onto the expanded pipe end located on the supporting sleeve. It is also possible, however, to implement the axial fixing of the connected pipe end using a compression sleeve. WO 02/077510 A1 is an example of such a pipe connection.

One example of an expansion tool required with a sliding sleeve fitting system is specified in EP 1 674 241 B1. Such an expansion tool has multiple segments that can be moved radially away from each other, between which a mandrel is centrally inserted that leads to radial disengagement of the expanded segments in order to expand a pipe end that was previously slid onto the expansion segment.

For pressing press fittings, pressing tools exist that can also be driven mechanically (see for example, WO 2004/096499 A1, EP 0 611 613 B1 and EP 0 504 490 B1). Thus, the assembly effort for connecting a pipe to a sliding sleeve fitting is increased due to the two assembly steps of expanding and sliding or pressing.

Therefore, the object of the invention is to create a tool device for the connection of a plastic pipe to a fitting having a compression sleeve or sliding sleeve, where the pressing device compensates at least partially for the increased assembly effort.

To achieve this objective, a tool device according to the claim 1 or 2 is proposed. Further embodiments are the subject matter of the dependent claims.

Thus, with the invention a tool device is proposed for the connection of a plastic pipe, particularly a plastic/metal composite pipe to a fitting having a compression sleeve or a sliding sleeve, wherein the tool device is provided with
a tool device for the connection of a plastic pipe, particularly a plastic/metal composite pipe, to a fitting have a compression sleeve or sliding sleeve, having a housing
a mechanically drivable drive element which can be selectively moved along a first movement direction or along a second movement direction,
a pipe expanding tool for expanding a pipe end that can be slid onto a supporting sleeve of a fitting, and
a compression sleeve-pressing tool or a sliding sleeve-sliding tool for pressing a compression sleeve onto the expanded pipe end slid onto the supporting sleeve of the fitting, or for sliding a sliding sleeve onto the expanded pipe end slid onto the supporting sleeve,
wherein during movement along the first movement direction the drive element actuates the pipe expanding tool and during movement along the second movement direction it actuates the compression sleeve-pressing tool or the sliding sleeve-sliding tool.

Thus, this invention proposes a combination tool whose mechanically drivable drive element is actuated selectively for a pipe expansion tool, or for a tool for a compression sleeve or a sliding sleeve. Here, both tools (expansion tool and compression sleeve-pressing tool or sliding sleeve-sliding tool) are located on/in a common housing, on/in which the drive element can be moved selectively along a first movement direction or along a second movement direction. The movement of the driving tool can occur here in a translational or rotational manner. The decisive factor is that by appropriate actuation of an actuating element (e.g., switch or similar), either the pipe expansion tool or the pressing-sliding tool can be operated using the drive element.

Advantageously, the drive element can be moved in a translational and mechanical manner. The mechanical movement of the drive element for this purpose advantageously takes place hydraulically. The hydraulic device necessary for this has a piston-cylinder unit, wherein the piston can be guided out of the cylinder unit on two opposite face sides, in order to actuate either the pipe expansion tool or the pressing tool or the sliding tool, depending on the movement direction.

The invention is explained in more detail in the following based on several example embodiments. The figures show:

FIG. 1 a schematic representation of a combined pressing and expansion tool in the state in which the pressing tool can be operated,

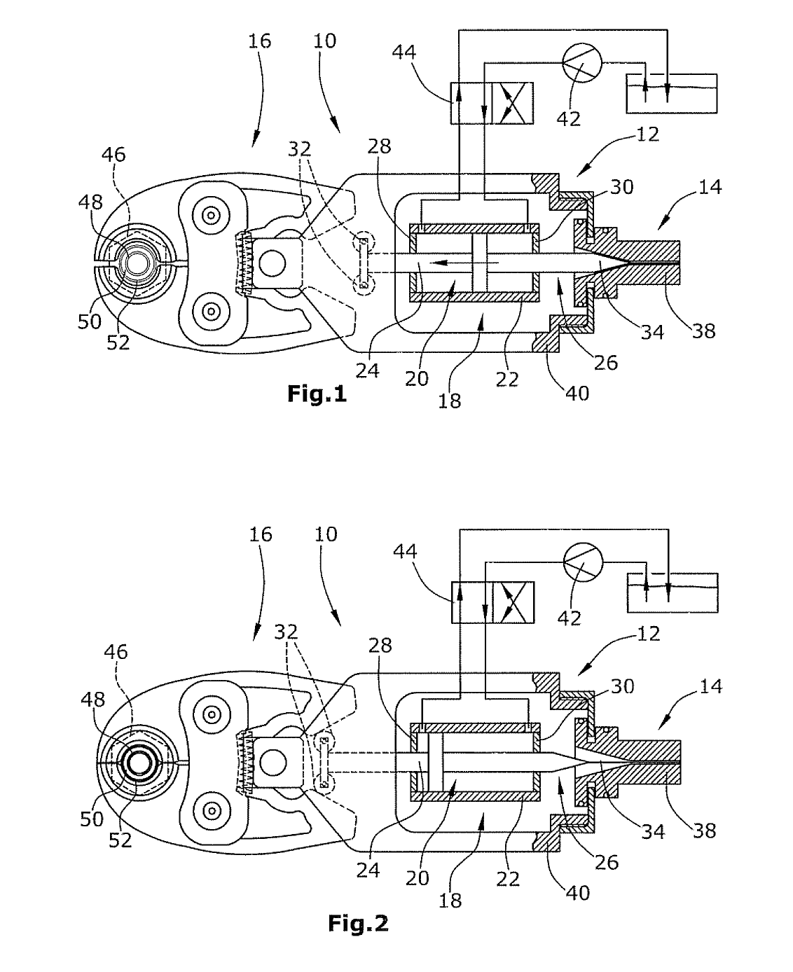

FIG. 2 a representation of the pressing tool according to FIG. 1 with the pressing tool actuated,

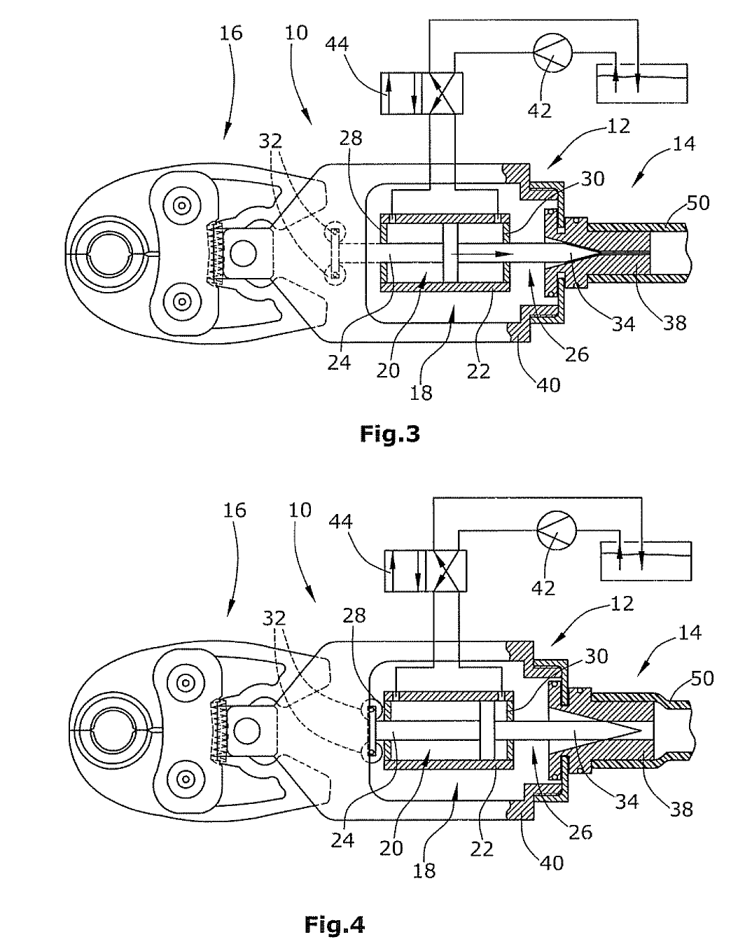

FIG. 3 a schematic representation of a combined pressing and expansion tool in the state in which the expansion tool can be operated,

FIG. 4 a representation of the expansion tool according to FIG. 1 with the expansion tool actuated,

FIG. 5 a schematic representation of a combined sliding sleeve and expansion tool in the state in which the sliding sleeve tool can be operated, and

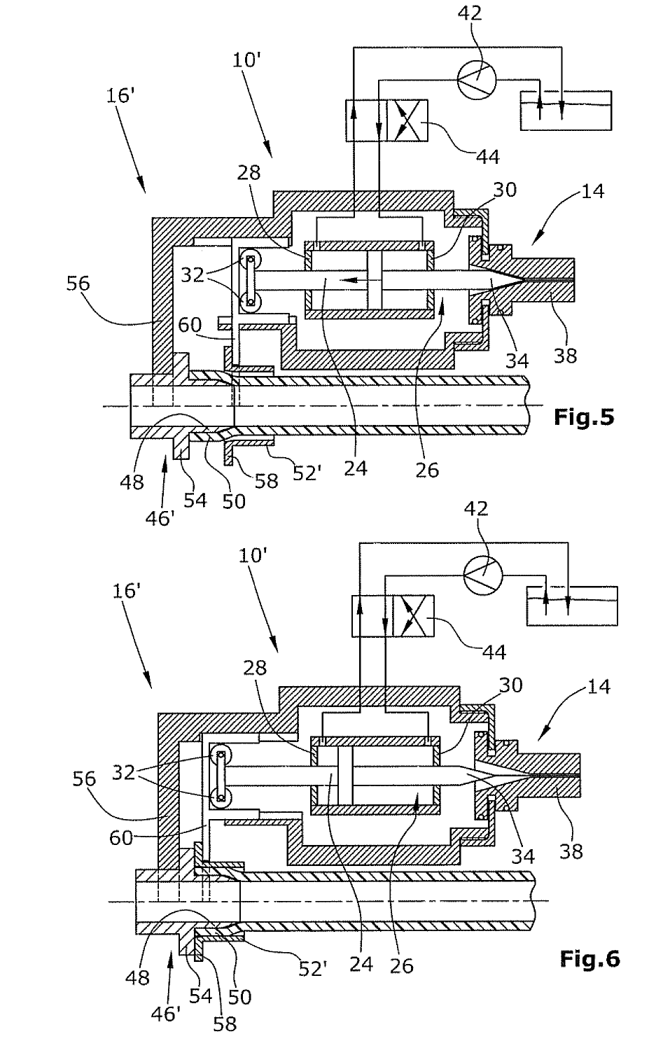

FIG. 6 a representation of the sliding sleeve tool according to FIG. 1 with the actuated sliding sleeve tool.

The FIGS. 1 to 4 show a first example embodiment of a combination tool device 10 in which a drive unit 12 is used optionally for the operation of a pipe expansion tool 14 or a compression sleeve-pressing tool 16. The drive unit 12 is a hydraulic drive of a piston-cylinder unit 18, which comprises a piston 20 and a cylinder 22. The piston 20 comprises a first piston rod 24 and a second piston rod 26, which are guided out of the cylinder 22 at its two opposite face walls 28, 30. The first piston rod 24 comprises pressure rollers 32 for operating the pressing tool, while the second piston rod 26 is designed as a spreader mandrel 34 that can be guided centrally in between expansion segments 38 of the expansion tool 14. The pressing and pipe expansion tools 16, 14 are customary, known tools that will not be described further in the context of the description of the invention. The two tools are located on the opposite ends of a tool housing 40 that further comprises a hydraulic pump 42 and a switching valve 44.

In the setting of the switching valve 44 according to FIG. 1, with the activation of the hydraulic pump 42, the piston 20 can be advanced in the direction of the pressing tool 16. A press fitting 46 that is located in the pressing tool 16, has a supporting sleeve 48 upon which the pipe end 50 is slid, and with compression sleeve 52 surrounding the pipe end 50 from the outside. FIG. 2 shows the situation during activation of the pressing tool 16, wherein the press fitting 46 is pressed.

The pipe 50 to be connected can have been expanded previously using the expansion tool 14 with use of the tool device 10. This is represented in the FIGS. 3 and 4. For this purpose, according to FIG. 3, the switching valve 44 is in the position in which on activation of the hydraulic pump 42 the piston 20 is moved in the direction towards the pipe expansion tool 14 or its expansion segment 38. FIG. 4 shows the resulting situation in the expanded state of the expansion tool 14.

The FIGS. 5 and 6 show an alternatively formed tool device 10′, which also has a pipe expansion tool 14, however in contrast to the tool device 10 in FIGS. 1 to 4, it is provided with a sliding tool 16′. Insofar as the individual components and elements of the tool device 10′ are respectively the same as those of the tool device 10, they are designated with the same reference numbers in FIGS. 5 and 6 as in the FIGS. 1 to 4.

In the example embodiment of FIGS. 5 and 6, for the connection of the expanded pipe 50 to the fitting 46′, a sliding sleeve 52′ is now pulled axially onto the expanded pipe 50. For this purpose, the sliding tool 16′ comprises an encompassing element 56 encompassing a collar 54 of the fitting 46′, against which a sliding element 60 is slid that is contacting the outer flange 58 of the sliding sleeve 52′, in particular, using the first piston 24. The completely slid-on state of the sliding sleeve 52′ is shown in FIG. 6.

1. A tool device for connecting a plastic pipe, particularly a plastic/metal composite pipe, to a fitting having a compression sleeve, having
a housing,
a pipe expanding tool for expanding a pipe end, which can be slid onto a supporting sleeve of a fitting, and
a compression sleeve-pressing tool for pressing a compression sleeve onto the expanded pipe end having been slid onto the supporting sleeve of the fitting,
characterized in that
the tool device comprises a mechanically drivable drive element, that can be moved selectively along a first movement direction or along a second movement direction,
wherein during movement along the first movement direction the drive element actuates the pipe expanding tool and during movement along the second movement direction actuates the compression sleeve-pressing tool.

2. A tool device for connecting a plastic pipe, particularly a plastic/metal composite pipe, to a fitting having a sliding sleeve, having
a housing,
a pipe expanding tool for expanding a pipe end, which can be slid onto a supporting sleeve of a fitting, and
a sliding sleeve-sliding tool for sliding a sliding sleeve onto the expanded pipe end slid onto the supporting sleeve of the fitting,
characterized in that
the tool device comprises a mechanically drivable drive element, that can be moved selectively along a first movement direction or along a second movement direction,
wherein the drive element during movement along the first movement direction actuates the pipe expanding tool and during movement along the second movement direction actuates the sliding sleeve-sliding tool.

3. The tool device according to claim 1, wherein the drive element (20) can be moved mechanically in a translational manner.

4. The tool device according to claim 1, wherein the drive element can be moved hydraulically.

5. The tool device according to claim 4, wherein the drive element is designed as a piston of a hydraulic piston-cylinder unit, wherein the piston comprises a first and second piston rod each of which are guided out of opposite face walls of the piston-cylinder unit.

6. The tool device according to claim 5, wherein the first piston rod comprises pressure rollers for operating the pressing tool or sliding tool.

7. The tool device according to claim 5, wherein the second piston rod is designed as a spreader mandrel that can be driven centrally in between expansion segments of the pipe expansion tool.

8. The tool device according to claim 2, wherein the drive element can be moved mechanically in a translational manner.

9. The tool device according to claim 2, wherein the drive element can be moved hydraulically.

10. The tool device according to claim 3, wherein the drive element can be moved hydraulically.

11. The tool device according to 6, wherein the second piston rod is designed as a spreader mandrel that can be driven centrally in between expansion segments of the pipe expansion tool.
